(19) United States
(12) Patent Application Publication
(10) Pub. No.: US 2019/0289316 A1
(43) Pub. Date: Sep. 19, 2019

(54) Method and Apparatus of Motion Vector Derivation for VR360 Video Coding

(71) Applicant: MEDIATEK INC., Hsin-Chu City (TW)

(72) Inventors: Cheng-Hsuan SHIH, Hsin-Chu (TW); Jian-Liang LIN, Hsin-Chu (TW)

(21) Appl. No.: 16/354,303

(22) Filed: Mar. 15, 2019

Related U.S. Application Data
(60) Provisional application No. 62/644,636, filed on Mar. 19, 2018.

(51) Int. Cl. H04N 19/52; H04N 19/176

(52) U.S. Cl. CPC H04N 19/52; H04N 19/176

(57) ABSTRACT

Method and apparatus of coding 360-degree virtual reality (VR360) pictures are disclosed. According to the method, when a first MV (motion vector) of a target neighboring block for the current block is not available within the 2D projection picture, or when the target neighboring block is not in a same face as the current block: a true neighboring block picture corresponding to the target neighboring block is identified within the 2D projection; if a second MV of the true neighboring block exists, the second MV of the true neighboring block is transformed into a derived MV; and a current MV of the current block is encoded or decoded using the derived MV or one selected candidate in a MV candidate list including the derived MV as an MV predictor.

### CROSS REFERENCE TO RELATED APPLICATIONS

The present invention claims priority to U.S. Provisional Patent Application Ser. No. 62/644,636, filed on Mar. 19, 2018. The U.S. Provisional patent application is hereby incorporated by reference in its entirety.

### FIELD OF THE INVENTION

The present invention relates to picture processing for 360-degree virtual reality (VR) pictures. In particular, the present invention relates to motion vector derivation for VR360 video coding.

### BACKGROUND AND RELATED ART

The 360-degree video, also known as immersive video is an emerging technology, which can provide “feeling as sensation of present”. The sense of immersion is achieved by surrounding a user with wrap-around scene covering a panoramic view, in particular, 360-degree field of view. The “feeling as sensation of present” can be further improved by stereographic rendering. Accordingly, the panoramic video is being widely used in Virtual Reality (VR) applications.

Immersive video involves the capturing a scene using multiple cameras to cover a panoramic view, such as 360-degree field of view. The immersive camera usually uses a panoramic camera or a set of cameras arranged to capture 360-degree field of view. Typically, two or more cameras are used for the immersive camera. All videos must be taken simultaneously and separate fragments (also called separate perspectives) of the scene are recorded. Furthermore, the set of cameras are often arranged to capture views horizontally, while other arrangements of the cameras are possible.

The 360-degree virtual reality (VR) pictures may be captured using a 360-degree spherical panoramic camera or multiple pictures arranged to cover all filed of views around 360 degrees. The three-dimensional (3D) spherical picture is difficult to process or store using the conventional picture/video processing devices. Therefore, the 360-degree VR pictures are often converted to a two-dimensional (2D) format using a 3D-to-2D projection method, such as EquiRectangular Projection (ERP) and CubeMap Projection (CMP). Besides the ERP and CMP projection formats, there are various other VR projection formats, such as OctaHedron Projection (OHP), icosahedron projection (ISP), Segmented Sphere Projection (SSP) and Rotated Sphere Projection (RSP) that are widely used in the field.

The VR360 video sequence usually requires more storage space than the conventional 2D video sequence. Therefore, video compression is often applied to VR360 video sequence to reduce the storage space for storage or the bit rate for streaming/transmission.

The High Efficiency Video Coding (HEVC) standard is developed under the joint video project of the ITU-T Video Coding Experts Group (VCEG) and the ISO/IEC Moving Picture Experts Group (MPEG) standardization organizations, and is especially with partnership known as the Joint Collaborative Team on Video Coding (JCT-VC). VR360 video sequences can be coded using HEVC. However, the present invention may also be applicable for other coding methods.

In HEVC, one slice is partitioned into multiple coding tree units (CTU). For color pictures, a color slice may be a partitioned into multiple coding tree blocks (CTB). The CTU is further partitioned into multiple coding units (CUs) to adapt to various local characteristics. HEVC supports multiple Intra prediction modes and for Intra coded CU, the selected Intra prediction mode is signaled. In addition to the concept of coding unit, the concept of prediction unit (PU) is also introduced in HEVC. Once the splitting of CU hierarchical tree is done, each leaf CU is further split into one or more prediction units (PUs) according to prediction type and PU partition. After prediction, the residues associated with the CU are partitioned into transform blocks, named transform units (TUs) for the transform process.

Inter prediction is an important coding tool in video coding. For Inter prediction, a current block is predicted from one or more reference block in one or more reference pictures. A motion vector is derived to locate a best candidate block as the predictor. Furthermore, in order to improve the coding efficiency, Merge mode and AMVP (Advanced Motion Vector Prediction) mode are used for coding motion vector. In the Merge mode, the current motion vector is coded by “merging” with a neighboring motion vector (spatial or temporal candidate). In other words, the current motion vector (MV) is the same (MV value and reference picture index) as the merged motion vector candidate. There is no need to signal motion vector information except for an index to identify the selected Merge candidate in the Merge candidate list. In the AMVP mode, the differences between the current MV and the selected AMVP candidate are coded.

For VR360 videos, some projection packing formats pack projection faces together as a traditional video frame and discontinuous face edge may exist in video. FIG. 1 illustrates an example of motion vector derivation for a VR360 picture 110. In FIG. 1, v2 is the MV of the current block 112 and v1 is the MV of block B₀ 114, where both the current block 112 and block B₀ 114 are in the same face. The neighboring blocks used for Merge or AMVP candidate are shown in illustration 120. In this case, due to correlation in neighboring blocks, MV v1 of block B₀ may be similar to MV v2 of the current block. Consequently, using v1 as a predictor for v2 may help to improve the coding efficiency. However, the current block and neighboring block B₀ may be in different faces as shown in FIG. 2. FIG. 2 illustrates an example of motion vector derivation for a VR360 picture 210. In FIG. 2, v2 is the MV of the current block 212 and v1 is the MV of block B₀ 214. In this case, taking v1 as a predictor of v2 is improper because the video contents of these two blocks may be irrelevant. In general, two MVs cannot be referred to each other if they are in different faces.

As illustrated in FIG. 2, the conventional MV derivation may not work properly for VR360 pictures. Therefore, it is desirable to develop MV derivation methods that will take into account the characteristics of VR360 pictures.

Within a VR360 picture, there may exist many faces and face edges. The picture content may be continuous through some of face edge and discontinuous for other face edges within a VR360 picture. FIG. 3 illustrates face edges within a VR360 picture for various projection formats. In FIG. 3(A), the 3×2 Cubemap Projection (CMP) format 310 is shown, where the dashed line indicate a discontinuous face edge and the dot-dashed line indicates a continuous face edge. FIG. 3(B) illustrates continuous and discontinuous face edges within a VR360 picture in the CMP format with 3×4 packing 320). FIG. 3(C) illustrates continuous and discontinuous face edges within a VR360 picture in the Barrel layout format 330. FIG. 3(D) illustrates continuous and discontinuous face edges within a VR360 picture in another CMP format with 3×4 packing 340. FIG. 3(E) illustrates continuous and discontinuous face edges within a VR360 picture in the Segmented-Sphere Projection (SSP) format 350.

FIG. 4 illustrates face edges within a VR360 picture for more projection formats, where the dashed line indicate a discontinuous face edge and the dot-dashed line indicates a continuous face edge. FIG. 4(A) illustrates continuous and discontinuous face edges within a VR360 picture in the Octahedron Projection (OHP) format 410. FIG. 4(B) illustrates continuous and discontinuous face edges within a VR360 picture in the Rotated Sphere Projection (RSP) format 420. FIG. 4(C) illustrates continuous and discontinuous face edges within a VR360 picture in the Icosahedron Projection (ISP) format 430). FIG. 4(D) illustrates continuous and discontinuous face edges within a VR360 picture in the Adjusted Cubemap Projection (ACP) format 440.

### BRIEF SUMMARY OF THE INVENTION

Method and apparatus of coding 360-degree virtual reality (VR360) pictures are disclosed. According to the method, input data for a current block in a 2D (two-dimensional) projection picture are received, wherein the 2D projection picture is projected from a 3D (three-dimensional) picture according to a target projection format. When a first MV (motion vector) of a target neighboring block for the current block is not available within the 2D projection picture, or when the target neighboring block is not in a same face as the current block: a true neighboring block picture corresponding to the target neighboring block is identified within the 2D projection; if a second MV of the true neighboring block exists, the second MV of the true neighboring block is transformed into a derived MV; and a current MV of the current block is encoded or decoded using the derived MV or one selected candidate in a MV candidate list including the derived MV as an MV predictor.

The method may further comprises, when the first MV of the target neighboring block for the current block is available and the target neighboring block is in the same face as the current block, encoding or decoding the current MV of the current block using the first MV of the target neighboring block or one selected candidate in the MV candidate list including the first MV of the target neighboring block as the MV predictor.

In one embodiment, the true neighboring block is identified using a projection-mapping function related to projection and mapping between the 3D picture and the 2D projection picture. For example, the projection-mapping function may project a target point outside a current face containing the current block to a corresponding point on a sphere and the projection-mapping function projects the corresponding point on the sphere to a mapped point in another face, and the true neighboring block is identified as an enclosing block containing the mapped point. In another example, the projection-mapping function may project a target point outside a current face containing the current block to a mapped point in another face, and the true neighboring block is identified as an enclosing mapped block containing the mapped point.

In another embodiment, the true neighboring block is identified using packing information related to projection between the 3D picture and the 2D projection picture. For example, the packing information can be used to locate a corresponding point in a continuous-boundary neighboring face adjacent to a current face in the 3D picture, and wherein the corresponding point corresponds to a target point outside the current face containing the current block; a true point in a target face corresponding to the continuous-boundary neighboring face in the 2D projection picture is located; and the true neighboring block in the target face is identified as an enclosing block in the target face containing the true point. In another example, when a target point outside a current face containing the current block is not within any continuous-boundary neighboring face, the packing information is used to map the target point to a corresponding point in a continuous-boundary neighboring face adjacent to the current face in the 3D picture; and wherein the true neighboring block is identified as an enclosing block in the continuous-boundary neighboring face containing the corresponding point. The packing information may comprise first information regarding neighboring faces for the current block and a corresponding rotation angle associated with each neighboring face.

In one embodiment, a mapping function is used to transform the second MV of the true neighboring block into the derived MV. For example, the mapping function can use a set of inputs comprising the second MV of the true neighboring block, a first location of the second MV of the true neighboring block, a first face enclosing the true neighboring block, a corresponding point in the 2D projection picture corresponding to the first location of the second MV of the true neighboring block, a second face enclosing the corresponding point and the target projection format.

In another embodiment, a projection-mapping function is used to transform the second MV of the true neighboring block into the derived MV. For example, the projection-mapping function may project the second MV of the true neighboring block in a first face enclosing the true neighboring block onto a second face enclosing the current block.

In another embodiment, packing information is used to derive the derived MV from the second MV of the true neighboring block. The packing information may comprise first information regarding neighboring faces for the current block and a corresponding rotation angle associated with each neighboring face.

The target projection format may correspond to Cubemap Projection (CMP), Barrel layout, Segmented-Sphere Projection (SSP), Octahedron Projection (OHP), Rotated Sphere Projection (RSP), Icosahedron Projection (ISP), or Adjusted Cubemap Projection (ACP).

The MV candidate list may correspond to a Merge candidate list or an AMVP (Advanced Motion Vector Prediction) candidate list.

### BRIEF DESCRIPTION OF THE DRAWINGS

FIG. 1 illustrates an example of motion vector derivation for a VR360 picture, where the current block and a reference block B₀ are in a same face.

FIG. 2 illustrates an example of motion vector derivation for a VR360 picture, where the current block and a reference block B₀ are in different faces.

FIG. 3 illustrates face edges within a VR360 picture for various projection formats, where the dashed line indicate a discontinuous face edge and the dot-dashed line indicates a continuous face edge.

FIG. 4 illustrates face edges within a VR360 picture for more projection formats, where the dashed line indicate a discontinuous face edge and the dot-dashed line indicates a continuous face edge.

FIG. 5 illustrates region edges within a VR360 picture for various projection formats.

FIG. 6 illustrates face edges within a VR360 picture for more projection formats.

FIG. 7 illustrates an example of MV derivation according to an embodiment of the present invention.

FIG. 8 illustrates an exemplary flowchart for MV derivation according to method 1 of the present invention.

FIG. 9A illustrates some examples of step 1 process of FIG. 8, where the solid small box indicates a current block and the dashed box indicates a neighboring block.

FIG. 9B illustrates some examples of step 2 process of FIG. 8, where the neighboring block is checked to determine whether it is in the same region as the current block.

FIG. 9C illustrates some examples of step 3 process of FIG. 8, where the position of the true neighboring block is found.

FIG. 9D illustrates some examples of step 4 process of FIG. 8, where the availability of the motion vector of the true neighboring block is checked.

FIG. 9E illustrates some examples of step 5 process of FIG. 8, where a mapping function which transforms the motion vector of true neighboring block to the region of the current block is applied.

FIG. 10 illustrates another exemplary flowchart for MV derivation according to Method 2 of the present invention.

FIG. 11A illustrates some examples of step 1 process of FIG. 10, where the solid small box indicates a current block and the dashed box indicates a neighboring block.

FIG. 11B illustrates some examples of step 2 process of FIG. 10, where the position of the true neighboring block is found.

FIG. 11C illustrates some examples of step 3 process of FIG. 10, where the availability of the motion vector of the true neighboring block is checked.

FIG. 11D illustrates some examples of step 4 process of FIG. 10, where a mapping function which transforms the motion vector of true neighboring block to the region of the current block is applied.

FIG. 12 illustrates an example of the process to find a true neighboring block for a VR360 picture in the Cubemap format.

FIG. 13 illustrates an example of the projection-mapping function that maps coordinate position in 3D space (e.g. a sphere) to the coordinate position in the plane (e.g. ERP).

FIG. 14 illustrates an example of the process to map a current block in region B to a true neighboring block using two steps of functions.

FIG. 15 illustrates an example of the process to map a current block in region B to a true neighboring block by combining the two functions of the process in FIG. 14.

FIG. 16 illustrates an example of 2D projection format where the six faces of a cube are packed into a 3×4-format picture or a 2×3-format picture.

FIG. 17 illustrates an example of finding true neighboring block by using packing information according to an embodiment of the present invention.

FIG. 18 illustrates another example of finding true neighboring block by using packing information according to an embodiment of the present invention

FIG. 19 illustrates examples of mapping rules for step B of the case shown in FIG. 18 according to one embodiment of the present invention.

FIG. 20 illustrates examples of mapping rules for step B of the case shown in FIG. 18 according to another embodiment of the present invention.

FIG. 21 illustrates an example of transforming the motion vector from one region to another.

FIG. 22 illustrates an example of transforming motion vector by using projection-mapping function according to one embodiment of the present invention.

FIG. 23 illustrates an example of transforming motion vector by using packing information for the cube projection format according to another embodiment of the present invention.

FIG. 24 illustrates an exemplary block diagram of a system incorporating the motion vector (MV) derivation method for VR360 video according to an embodiment of the present invention.

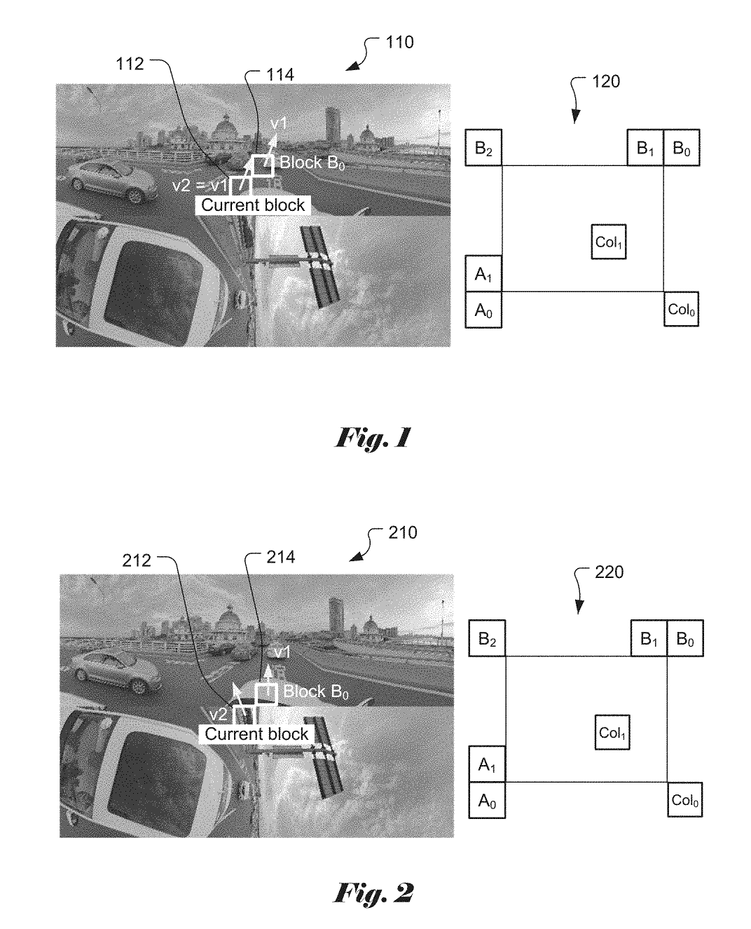

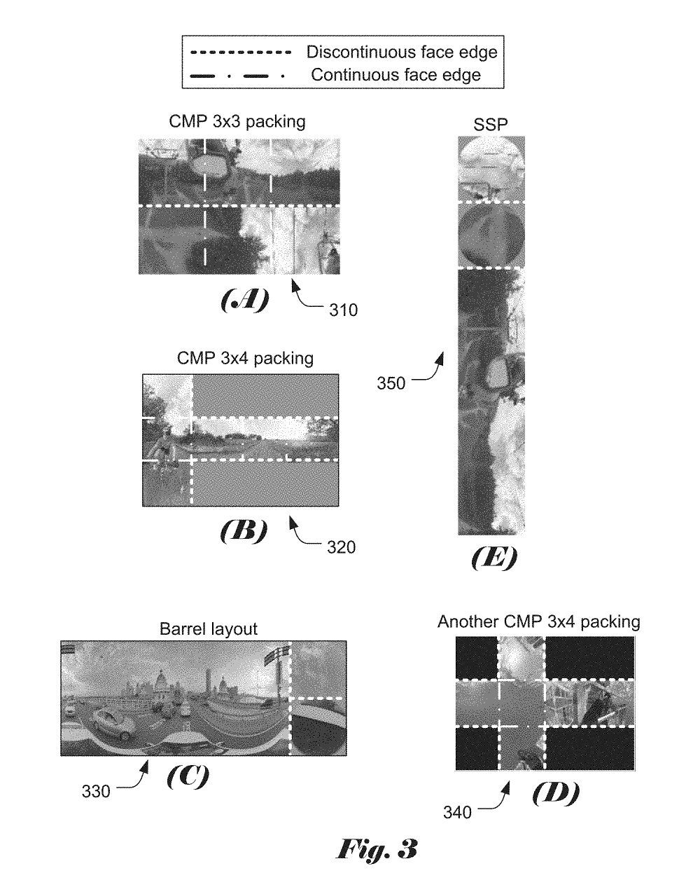

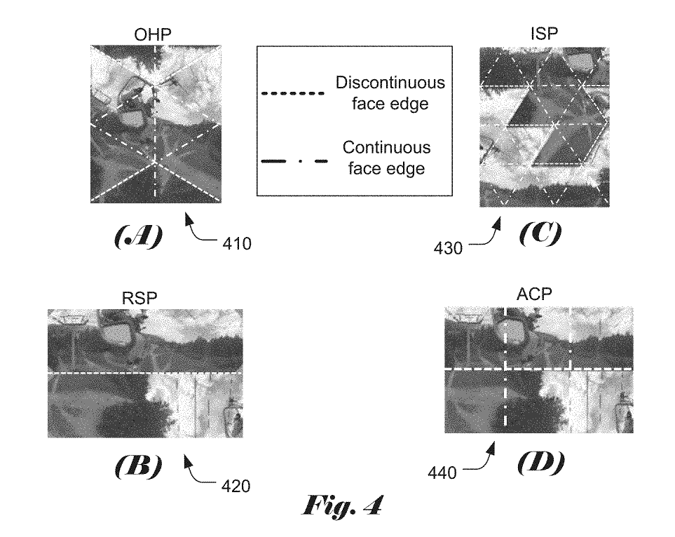

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention.

Reference throughout this specification to “one embodiment,” “an embodiment,” or similar language means that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

In the description like reference numbers appearing in the drawings and description designate corresponding or like elements among the different views.

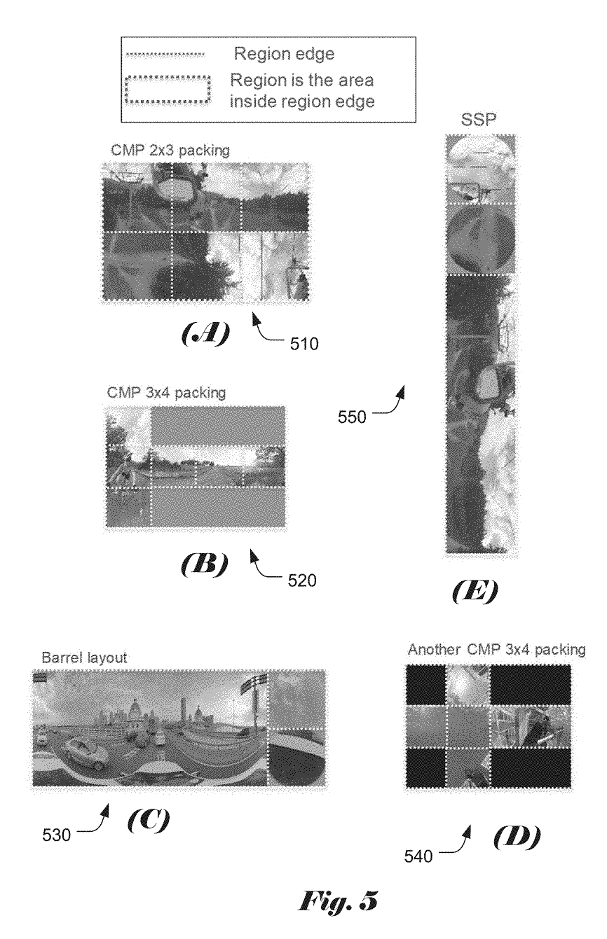

A region edge and region inside the region edges are defined for VR360 pictures. FIG. 5 illustrates region edges within a VR360 picture for various projection formats. In FIG. 5(A), the 2×3 Cubemap Projection (CMP) format 510 is shown, where the dashed lines indicate region edge and areas enclosed by the region edges correspond to regions. As shown in FIG. 5(A), some neighboring faces (i.e., regions) have a continuous boundary in between, where contents flow continuously from one face to another face across the edge. For example, any two faces in the top sub-frame or any two faces in the bottom sub-frame have continuous edge. These continuous-edge neighboring faces correspond to two neighboring faces on a corresponding polyhedron. For example, the 6 faces in the 2×3 projection format correspond to the 6 faces on a cube. The top 3 faces correspond to 3 neighboring faces on the cube and the bottom 3 faces correspond to another 3 neighboring faces on the cube. FIG. 5(B) illustrates region edges and regions for a VR360 picture in the CMP format with 3×4 packing 520). FIG. 5(C) illustrates region edges and regions for a VR360 picture in the Barrel layout format 530. FIG. 5(D) illustrates region edges and regions for a VR360 picture in another CMP format with 3×4 packing 540. FIG. 5(E) illustrates region edges and regions for a VR360 picture in the Segmented-Sphere Projection (SSP) format 550.

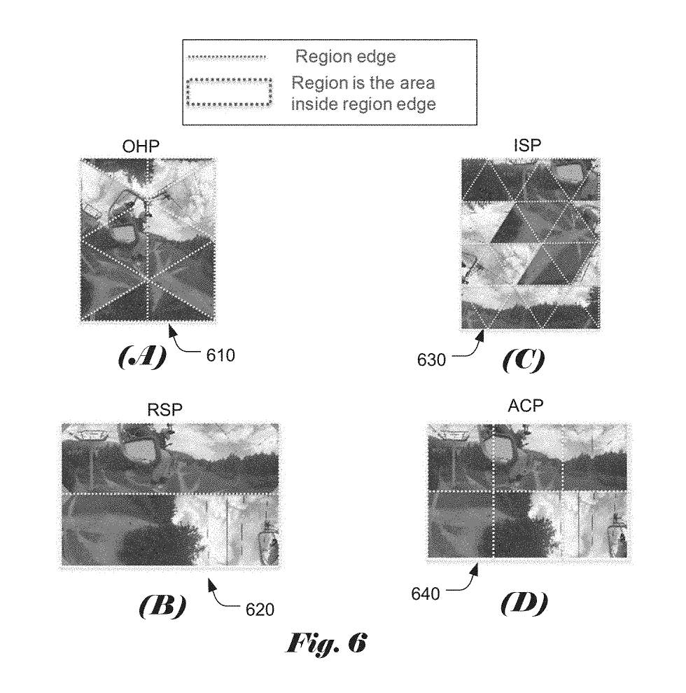

FIG. 6 illustrates face edges within a VR360 picture for more projection formats, where the dashed lines indicate region edge and areas enclosed by the region edges correspond to regions. FIG. 6(A) illustrates region edges and regions for a VR360 picture in the Octahedron Projection (OHP) format 610. FIG. 6(B) illustrates region edges and regions for a VR360 picture in the Rotated Sphere Projection (RSP) format 620. FIG. 6(C) illustrates region edges and regions for a VR360 picture in the Icosahedron Projection (ISP) format 630). FIG. 6(D) illustrates region edges and regions for a VR360 picture in the Adjusted Cubemap Projection (ACP) format 640.

Methods of Motion Vector (MV) Derivation for VR360

According to embodiments of the present invention, the true neighboring block of the current block is identified. The true neighboring block refers to a block that is a neighboring block to the current block in the 3D space. The motion vector of the true neighboring block is transformed to derive a new motion vector. The derived motion vector is then applied to Merge mode, Skip mode, Inter mode, AMVP (Advanced Motion Vector Prediction), or other prediction methods which refer to the MV of neighboring block.

An example of MV derivation according to an embodiment of the present invention is disclosed in FIG. 7 for a VR360 picture 710 in the 2×3 projection format with a discontinuous edge 712. The current block 714 and its neighboring block 716 are shown. However, the neighboring block 716 is across the discontinuous edge and the contents have low correlation with the current block. In other words, the neighboring block 716 is spatially adjacent to the current block in the 2×3 projection format, which is not the true neighboring block. According to an embodiment of the present invention, the true neighboring block 718 is identified according to the structure of the VR360 picture and the location of the current block. The v2 of the true neighboring block 718 is transformed to v2′ in the coordinate space of the current block and v2′ is used as a predictor for the current MV (v2). The true neighboring block 718 is in a continuous-boundary neighboring face of the current face enclosing the current block. According to the way that the 2×3 cubemap picture is generated, the top edge of the current face enclosing the current block is the same as the right edge of the face enclosing the true neighboring block.

MV Derivation for VR360 Method 1

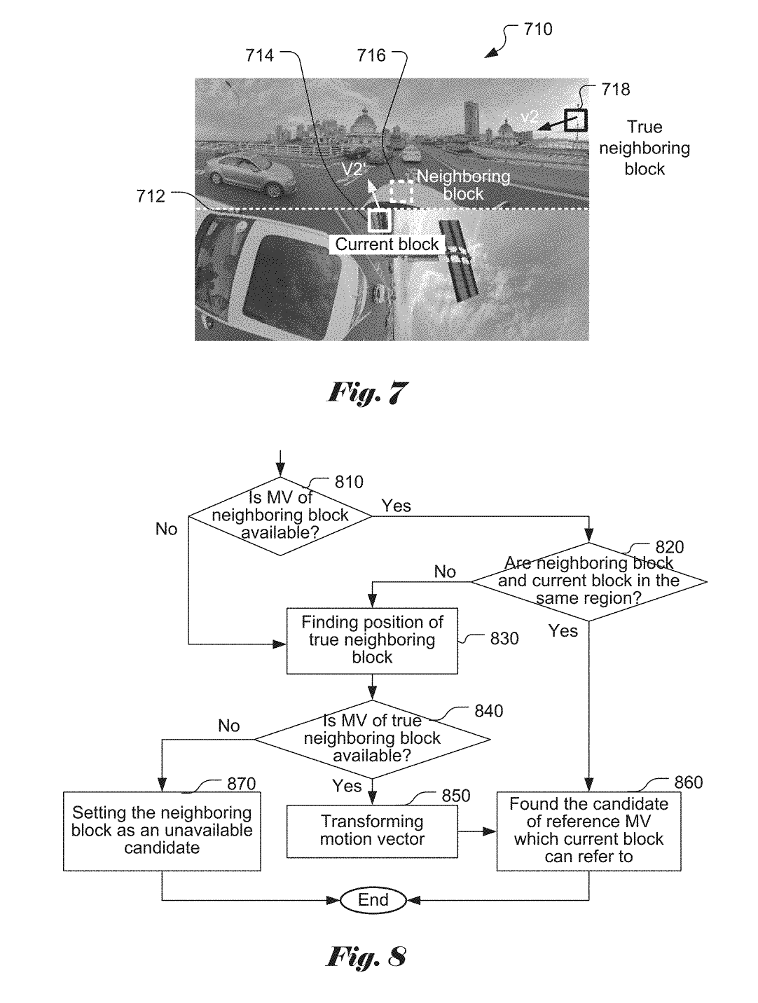

The method disclosed as follows can prevent misuse of irrelevant MVs. For the motion-vector (MV) referencing methods (e.g. Merge mode, AMVP, and other prediction methods) which refer to the MV of a neighboring block, the MV derivation method is described in FIG. 8.

Step 1 (810): Checking whether the motion vector of a neighboring block is available or not. If available, go to step 2; otherwise go to step 3.

Step 2 (820): Checking whether the neighboring block is in the same region as the current block. If yes, go to step 6. If not, go to step 3 (i.e., 830).

Step 3 (830): Finding the position of true neighboring block of the current block and go to step 4 (i.e., 840).

Step 4 (840): Checking whether the motion vector of the true neighboring block is available or not. If yes, go to step 5; otherwise go to step 7.

Step 5 (850): Applying a mapping function which transforms the motion vector of the true neighboring block to the region of the current block. Go to step 6 (i.e., 860).

Step 6 (860): Taking the (transformed) motion vector as the reference MV of the current block. The procedures is terminated.

Step 7 (870): If the neighboring block is not an available candidate for Inter prediction, mark the candidate as unavailable. The procedures is terminated.

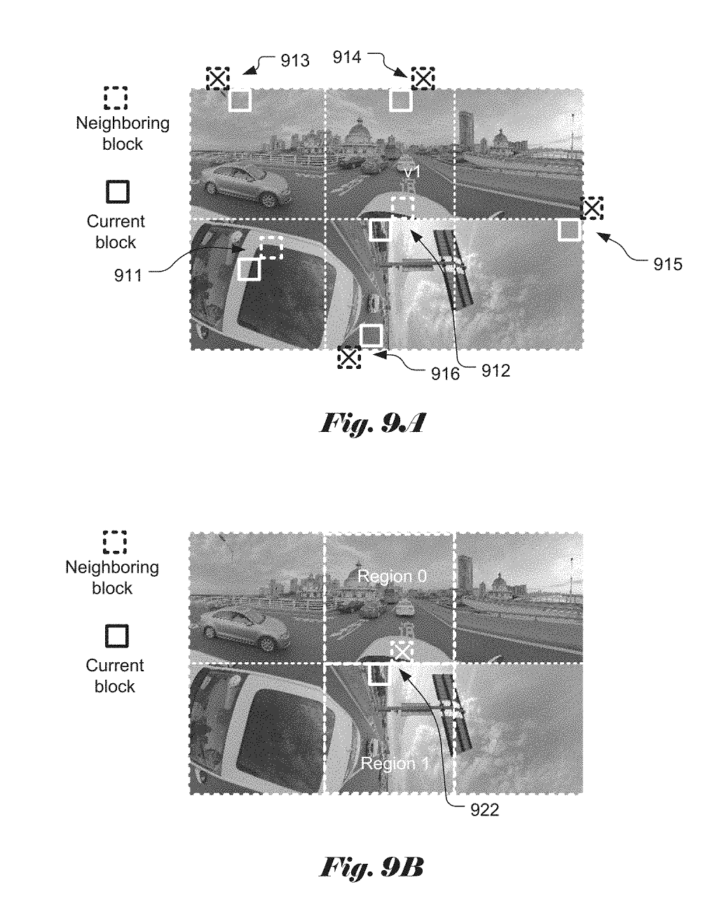

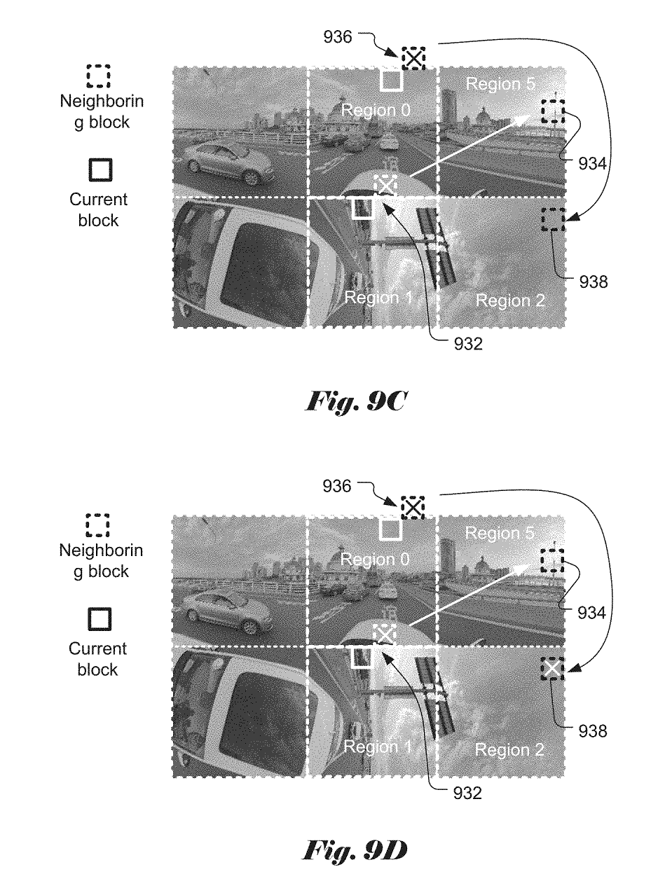

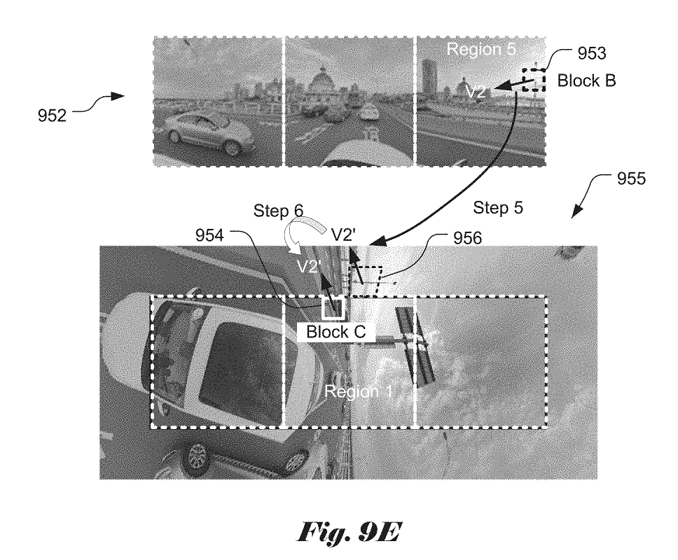

The steps are described in details in the following examples. FIG. 9A illustrates some examples of step 1 process. In FIG. 9A, the solid small box indicates a current block and the dashed box indicates a neighboring block. For each current block, a corresponding neighboring block is located. As shown in FIG. 9A, the neighboring block for some cases is not available. For example, the neighboring blocks for cases 911 and 912 are available. However, the neighboring blocks for cases 913 through 916 are unavailable, where an “X” is used to indicate the unavailable neighboring blocks.

Some examples of step 2 are shown in FIG. 9B. In step 2, the neighboring block is checked to determine whether it is in the same region as the current block. If they are in the same region, the MV of the neighboring block can be referred by the current block. If not, go to step 3. In FIG. 9B, while the neighboring is available in the case 922, the neighboring block is in Region 0 while the current block is in Region 1. According to an embodiment of the present invention, the neighboring block cannot be used as a referred as a predictor (as shown by an “X”).

Some examples of step 3 are shown in FIG. 9C. In step 3, the position of the true neighboring block is found and the process goes to step 4. The true neighboring block of block can be determined based on the structure of the projection format and the location of the current block. For example, the Cubemap picture is unfolded from a cube and the connectivity between faces can be determined accordingly. For example, in case 932, the true neighboring block for the current block corresponds to block 934 since the Region 1 is connected to Region 5. In case 936, the true neighboring block 938 for the current block can be found in Region 2.

Some examples of step 4 are shown in FIG. 9D. In step 4, the availability of the motion vector of the true neighboring block is checked. If the MV exists, the process goes to step 5; otherwise go to step 7. In the examples of FIG. 9D, the MV of the true neighboring block 934 for case 932 is available and the MV of the true neighboring block 938 for case 936 is unavailable (as indicated by an “X”).

Some examples of step 5 are shown in FIG. 9E. In step 5, a mapping function which transforms the motion vector of true neighboring block B 953 in the upper sub-frame of the VR360 picture to the region of the current block C 954 is applied. The current block is located in Region 1 of the lower sub-frame of the VR360 picture. The connected neighboring area of the lower sub-frame is shown in picture 955. After transform, the corresponding block 956 for block B 953 is shown in FIG. 9E. The transformed MV V2′ associated with the corresponding block 956 is shown in FIG. 9E.

v2′=T_{region(B)→region(C)}(v2)

In the above equation, T_{region(B)→region(C)}(⋅) is the transform function. For picture 955, we can transform v2 to v2′ according to:

v2′=T_{region5→region1}(v2)

After step 5 is finished, the process goes to step 6.

In step 6, the (transformed) motion vector (i.e., v2′) is used as the reference MV of the current block C. The procedures is terminated.

In step 7, the neighboring block is not an available candidate for Inter prediction and the candidate is marked as unavailable. The procedures is terminated.

MV Derivation for VR360 Method 2

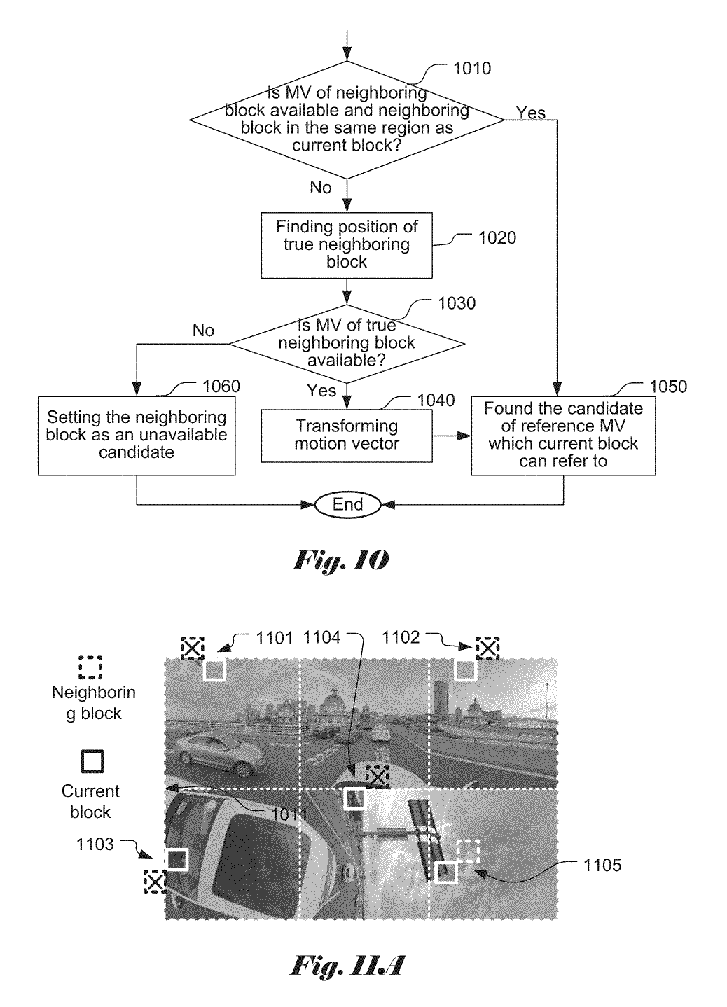

The method disclosed as follows can prevent misuse of irrelevant MVs. For the motion-vector (MV) referencing methods (e.g. Merge mode, AMVP, and other prediction methods) which refer to the MV of a neighboring block, the MV derivation method is described in FIG. 10. The processing flow is similar to that in FIG. 8. However, the steps 1 and 2 of Method 1 are combined into step 1 of Method 2.

Step 1 (1010): Checking whether the motion vector of neighboring block is available and whether the neighboring block is in the same region as the current block. If yes, go to step 5 (1050); otherwise go to step 2 (1020).

Step 2 (1020): Finding position of the true neighboring block of the current block and go to step 3 (1030).

Step 3 (1030): Checking whether the motion vector of the true neighboring block is available or not. If yes, go to step 4 (1040); otherwise go to step 6 (1060).

Step 4 (1040): Applying a mapping function which transforms the motion vector of the true neighboring block to the region of the current block. Go to step 5 (1050).

Step 5 (1050): Taking the (transformed) motion vector as the reference MV of the current block. The procedures is terminated.

Step 6 (1060): If the neighboring block is not an available candidate for Inter prediction, the candidate is marked as unavailable. The procedures is terminated.

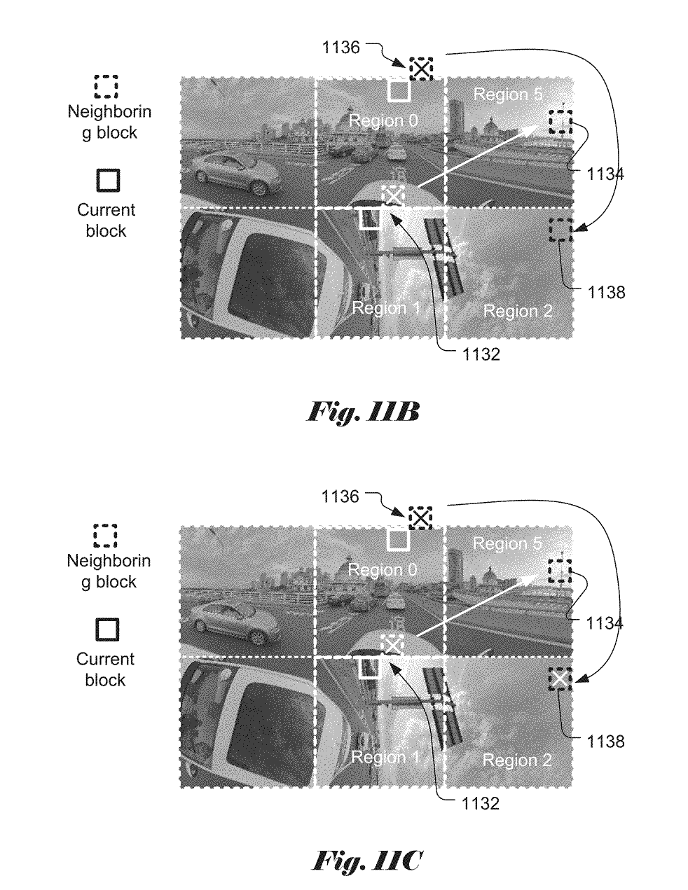

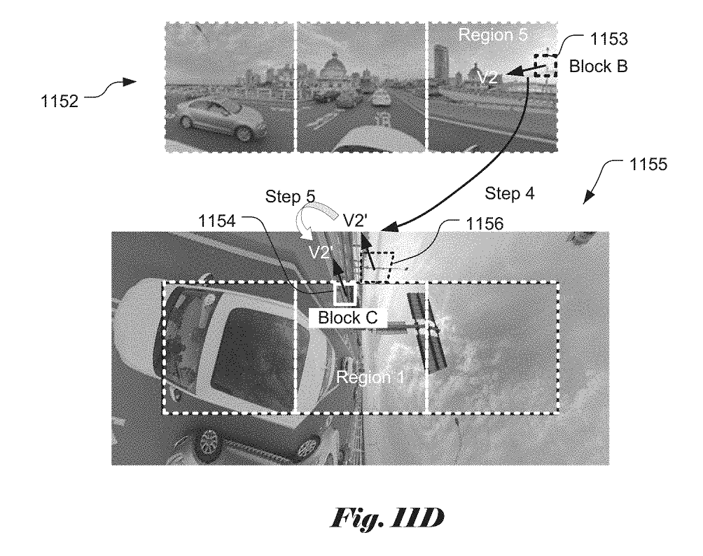

The steps are described in details in the following examples. FIG. 11A illustrates some examples of step 1 process. In FIG. 11A, the solid small box indicates a current block and the dashed box indicates a neighboring block. For each current block, a corresponding neighboring block is located. As shown in FIG. 11A, the neighboring block for some cases is not available (cases 1101, 1102 and 1103) and some neighboring blocks are not in the same region as the corresponding current block (case 1104). For these examples, the neighboring blocks are marked by an “X”. In FIG. 11A, only for case 1105, the neighboring block is available and the neighboring block is in the same region as the current block.

Some examples of step 2 are shown in FIG. 11B. In step 2, the position of the true neighboring block is found and the process goes to step 3. The true neighboring block of block can be determined based on the structure of the projection format and the location of the current block. For example, the Cubemap picture is unfolded from a cube and the connectivity between faces can be determined accordingly. For example, in case 1132, the true neighboring block for the current block corresponds to block 1134 since the Region 1 is connected to Region 5. In case 1136, the true neighboring block 1138 for the current block can be found in Region 2.

Some examples of step 3 are shown in FIG. 11C. In step 3, the availability of the motion vector of the true neighboring block is checked. If the MV exists, the process goes to step 4; otherwise go to step 6. In the examples of FIG. 11C, the MV of the true neighboring block 1134 for case 1132 is available and the MV of the true neighboring block 1138 for case 1136 is unavailable (as indicated by an “X”).

Some examples of step 4 are shown in FIG. 11D. In step 4, a mapping function which transforms the motion vector of true neighboring block B 1153 in the upper sub-frame of the VR360 picture to the region of the current block C 1154 is applied. The current block is located in Region 1 of the lower sub-frame of the VR360 picture. The connected neighboring area of the lower sub-frame is shown in picture 1155. After transform, the corresponding block 1156 for block B 1153 is shown in FIG. 11D. The transformed MV V2′ associated with the corresponding block 1156 is shown in FIG. 11D.

v2′=T_{region(B)→region(C)}(v2)

In the above equation, T_{region(B)→region(C)}(⋅) is the transform function. For picture 1155, we can transform v2 to v2′ according to:

v2′=T_{region5→region1}(v2)

After step 4 is finished, the process goes to step 5.

In step 5, the (transformed) motion vector (i.e., v2′) is used as the reference MV of the current block C. The procedures is terminated.

In step 6, the neighboring block is not an available candidate for Inter prediction and the candidate is marked as unavailable. The procedures is terminated.

Finding the True Neighboring Block

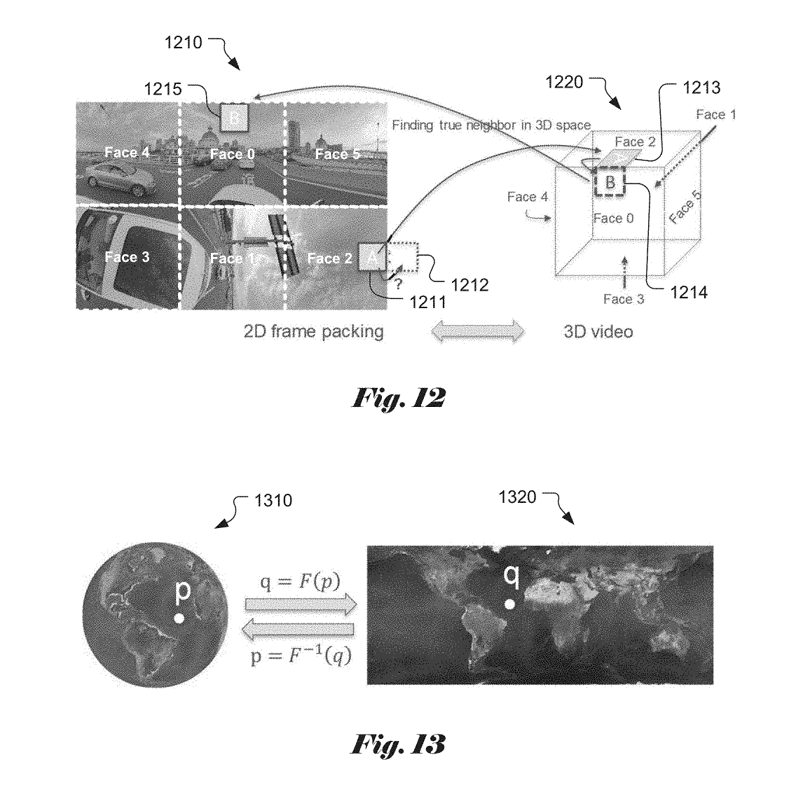

In the MV derivation methods as described above, one important step is to locate the true neighboring block. The true neighboring block is the block near the current block in 3D space which has high correlation with the current block. An example is shown in FIG. 12, where a VR360 picture 1210 in the Cubemap format corresponds to 6 faces lifted off from a cube 1220. For a current block A 1211 at the right edge of Face 2, the neighboring block 1212 is not available. The true neighboring block can be found by locating the block locations on the cube. For example, as shown in FIG. 12, the top edge of face 0 is the same as the right edge of face 2 and the corresponding block A location on the cube is block 1213. Therefore, the neighboring block on the cube is identified as block 1214 in Face 0 and the true neighboring block 1215 in the VR360 projection picture corresponding to block 1214 can be located. Two methods of identifying the true neighboring block are disclosed below.

I: Finding True Neighboring Block by Using Mapping Function

The VR360 picture can be projected onto a sphere in 3D space. The projection-mapping function is a 1-to-1 function which maps coordinate position in 3D space 1310 (e.g. a sphere) to the coordinate position in the plane 1320 (e.g. ERP), and the projection-mapping function is reversible which has an inverse function to it as shown in FIG. 13.

Suppose p is a point on sphere and we can use projection-mapping function to find the corresponding position on the plane q:

q=F(p)

The inverse of projection-mapping function can find the position of p from q:

p=F⁻¹(q)

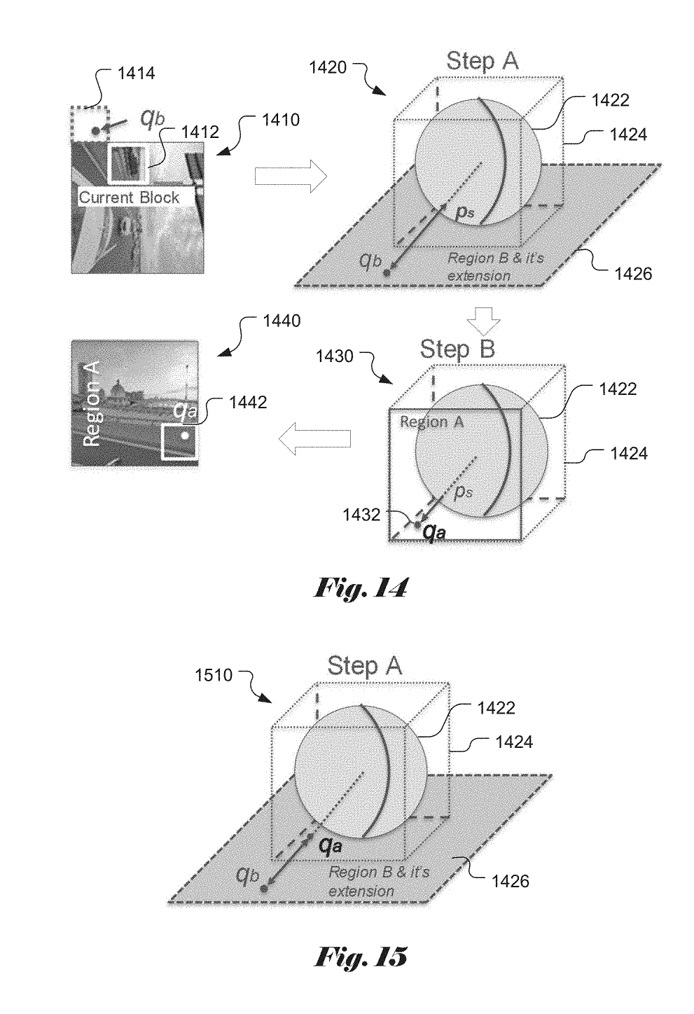

For a current block in region B and a point q_{b} outside region B, the true neighboring block of point q_{b} needs to be located. For projection-mapping functions F_{A} and F_{B} which map points from the sphere to the plane “Region A” and plane “Region B”, and their inverse functions are F_{A}⁻¹ and F_{B}⁻¹. In FIG. 14, picture 1410 corresponds to the Region B picture with a current block 1412 to the top edge. Block 1414 corresponds to a neighboring block of the current block 1412.

Step A: For the point q_{b} at Region B, we apply F_{B}⁻¹ to q_{b} and produce the corresponding point pₛ on the sphere 1422. Area 1426 corresponds to the Region B with its extended area including the point q_{b}. The cube 1424 consists of 6 faces projected from the sphere.

pₛ=F_{B}⁻¹(q_{b})

Step B: For a point pₛ on the sphere, we apply F_{A} to pₛ and produce the corresponding point qₐ (1432) at Region A.

qₐ=F_{A}(pₛ)

Step C: Finding the block 1442 where qₐ is located in Region A 1440, and the block is the true neighboring block of the current block.

Because the projection-mapping function is a 1-to-1 function, we can combine multiple projection-mapping functions into a single function.

For the step A and step B shown in above, we combine two functions together:

pₛ=F_{B}⁻¹(q_{b}) and qₐ=F_{A}(pₛ)

→qₐ=F_{A}(F_{B}⁻¹(q_{b}))→qₐ=F_{B→A}(q_{b})

Function F_{B→A} maps a point from region B to region A

The procedures of this method are shown in FIG. 15:

Step A 1510: For a point q_{b} at Region B (as shown in Picture 1410 in FIG. 14), we apply F_{B→A} to qb and produce the corresponding point qₐ at Region A

qₐ=F_{B→A}(q_{b})

Step B: Finding the block where qₐ is located, and the block is the true neighboring block of the current block. Step B for this combined mapping is the same as Step C in FIG. 14.

II: Finding True Neighboring Block by Using Packing Information

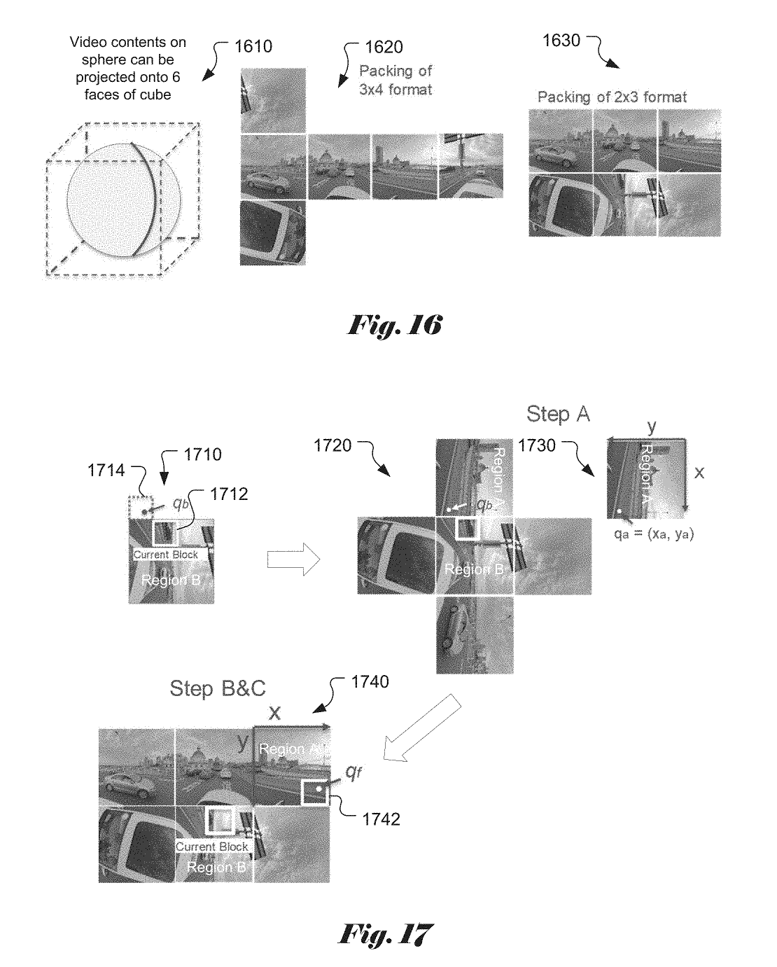

According to this method, the different parts of video contain of VR360 video can be projected to different planes. The projected plane is named as a “Face” in this disclosure. Multiple faces can be packed together as a frame. The way of packing multiple faces to a frame can be described as packing information and the packing information can be used to find the true neighboring block of the current block. For example, a VR360 frame corresponding 3D images on a sphere can be projected onto a six faces of a cube as shown in illustration 1610. The six faces of a cube can be packed into a 3×4-format picture 1620 or a 2×3-format picture 1630 as shown in FIG. 16.

FIG. 17 illustrates an example of finding true neighboring block by using packing information according to an embodiment of the present invention. For a current block 1712 at the edge of face B and a point q_{b} of a neighboring block 1714 outside of face B as shown in illustration 1710, we want to find the true neighboring block of point q_{b}.

Step A (1720 and 1730): Based on packing info, the neighboring faces of face B and the corresponding rotation angles of neighboring faces are known. According to these information, we try to find the face where q_{b} belongs to. Suppose q_{b} is in the position of face A.

Step B (1740): We represent q_{b} at face A as qₐ. The position of qₐ is (xa, ya). Based on packing info, we can map qₐ at face A to packing frame. Suppose qₐ maps to frame at q_{f}.

Step C (1740): Finding the block 1742 where q_{f} is located, and the block 1742 is the true neighboring block of current block

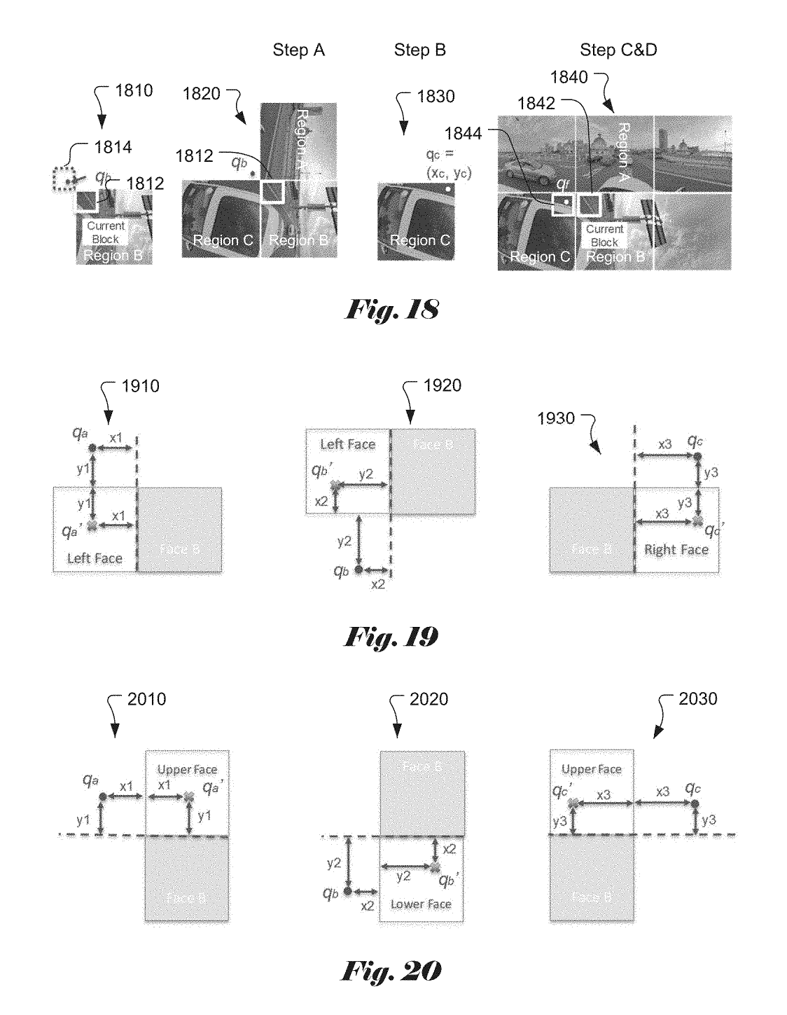

FIG. 18 illustrates another example of finding true neighboring block by using packing information according to an embodiment of the present invention. For a current block 1812 at the edge of face B and a point q_{b} of a neighboring block 1814 outside of face B as shown in illustration 1810, we want to find the true neighboring block of point q_{b}.

Step A (1820): Based on packing information, the neighboring faces (i.e., Faces A and C) of face B and the corresponding rotation angles of neighboring faces are known. According to these information, we try to find the face is the location of q_{b}. Furthermore, we assume that q_{b} is not located at any face in this example.

Step B (1830): We map q_{b} to one of the neighboring face of face B. Suppose we map q_{b} to face C at q_{c}. The mapping rules of this step are explained at next page.

Step C (1840): The position of q_{c} is (xc, yc). Based on packing info, we can map q_{c} in face C to the packing frame. Assume that q_{c} is mapped to frame C at q_{f} 1844, where the current block 1842 is indicated.

Step D (1840): Finding the block where q_{f} is located, and the block is the true neighboring block of current block.

The mapping rules for step B 1830 of the case shown in FIG. 18 is shown as follows:
Suppose the current block is at a position of face B.
For the position in the upper left corner of face B, referred as qₐ, we map qₐ to qₐ′. The qa′ is located in the left face of face B. The corresponding position of qₐ′ is shown in illustration 1910 of FIG. 19.
For the position in the lower left corner of face B, where is q_{b}, we map q_{b} to q_{b}′. The q_{b}′ is located in the left face of face B. The corresponding position of q_{b}′ is shown in illustration 1920 of FIG. 19.
For the position in the upper right corner of face B, where is q_{c}, we map q_{c} to q_{c}′. The q_{c}′ is located in the right face of face B. The corresponding position of qₐ′ is shown in illustration 1930 of FIG. 19.

The mapping rules for step B 1830 of the case shown in FIG. 18 is shown as follows according to another embodiment:
Suppose the current block is in the position of face B.
For the position in the upper left corner of face B, referred as qₐ, we map qₐ to qₐ′. The qₐ′ is located in the upper face of face B. The corresponding position of qₐ′ is shown in illustration 2010 of FIG. 20.
For the position in the lower left corner of face B, where is q_{b}, we map q_{b} to q_{b}′. The q_{b}′ is located in the lower portion of face B. The corresponding position of q_{b}′ is shown in illustration 2020 of FIG. 20.
For the position in the upper right corner of face B, where is q_{c}, we map q_{c} to q_{c}′. The q_{c}′ is located in the upper face of face B. The corresponding position of q_{c}′ is shown in illustration 2030 of FIG. 20.

Transforming Motion Vector

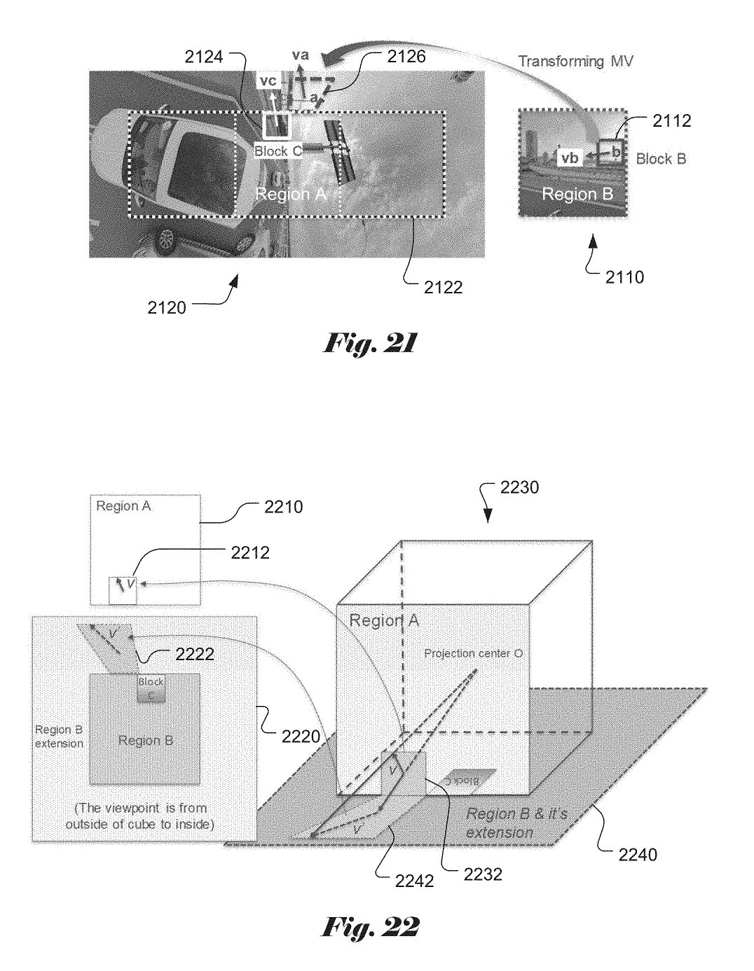

For the step 5 of Method 1 and step 4 of Method 2, the motion vector is transformed from one region to another. For example, the MV (i.e., vb) of block B 2112 in Region B needs to be transformed to a location a in a neighboring block 2126 for block C 2124 in Region A in FIG. 21. The motion vector va of block 2126 is used as the prediction for motion vector vc of block C 2124. The dash lines indicate three faces 2122 in a sub-frame within an extended region 2120. Three transform methods to transform motion vector are disclosed.

I: Transforming Motion Vector by Using Mapping Function

For a projection type P (e.g. ERP, CMP, or other projections), suppose a motion vector vb is at point b, and point b is at region B as shown in FIG. 21. We want to transform vb from b to a point a of region A 2126. A mapping function f(a, Region A, b, Region B, vb, P) can transform vb at b of Region B to va at a of Region A for a given projection type P.

The procedure of transforming motion vector is applying the mapping function f to MV vb:

va=f(a,Region A,b,Region B,vb,P)

II: Transforming Motion Vector by Using Projection-Mapping Function

MV v is a vector for block 2212 in region A and MV v′ is the “shadow” of MV v which projects MV v from region A 2210 to region B 2220 in FIG. 22. The v′ can be derived by applying projection-mapping function and its inverse function to the starting point and ending point of vector v:

v′=P_{region A→regionB}(v)

Picture 2220 corresponds to an extended region around Region B, where block C is located at top of Region B. The cube 2230 is shown in FIG. 22 with Region A labelled. Region B is on the bottom side of the cube 2230. The extended area 2240 corresponds to the extended area 2220. Block 2232 on Region A of the cube 2230 can be projected to the area 2242 in extended area 2240. Area 2242 corresponds to area 2222 in extended picture 2220.

III: Transforming Motion Vector by Using Packing Information

If the projection type is a polyhedron (e.g. tetrahedron, cube, octahedron, dodecahedron or icosahedron), we can join adjacent faces together by rotating surrounding faces to the center face to form a larger picture around the center face with continuous contents. After forming the joined picture, the true neighboring block can be identified. An example of the procedure for this method is shown below: Rotating the my of true neighboring block accordingly

v′=Rotation(v);

In the above equation, rotation function is based on packing information.

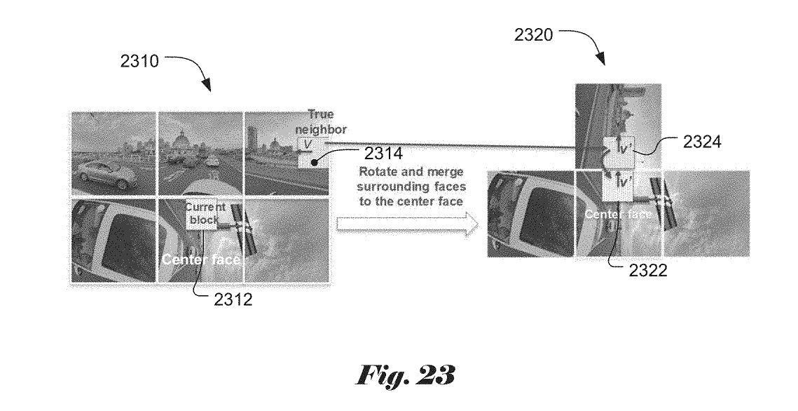

FIG. 23 illustrates an example of transforming motion vector by using packing information for the cube projection format. Picture 2310 corresponds to a VR360 picture in a 2×3 Cubemap format. Current block 2312 is location in the center face. The faces that are connected to the center face on the polyhedron (i.e., cube in this example) are joined with the center face to form a larger picture 2320 around the center face with continuous contents. The current block in the joined picture 2320 is labelled as block 2322 with its true neighboring block 2324 in the joined pictures 2320. In the joined picture, the MV v′ of the true neighboring block in the joined picture can be used as a predictor for the MV of the current block. The MV v′ needs to be rotated (e.g. the vertical MV v′ in picture 2320=>the horizontal MV v in picture 2310) before it can be used as the predictor for the current block.

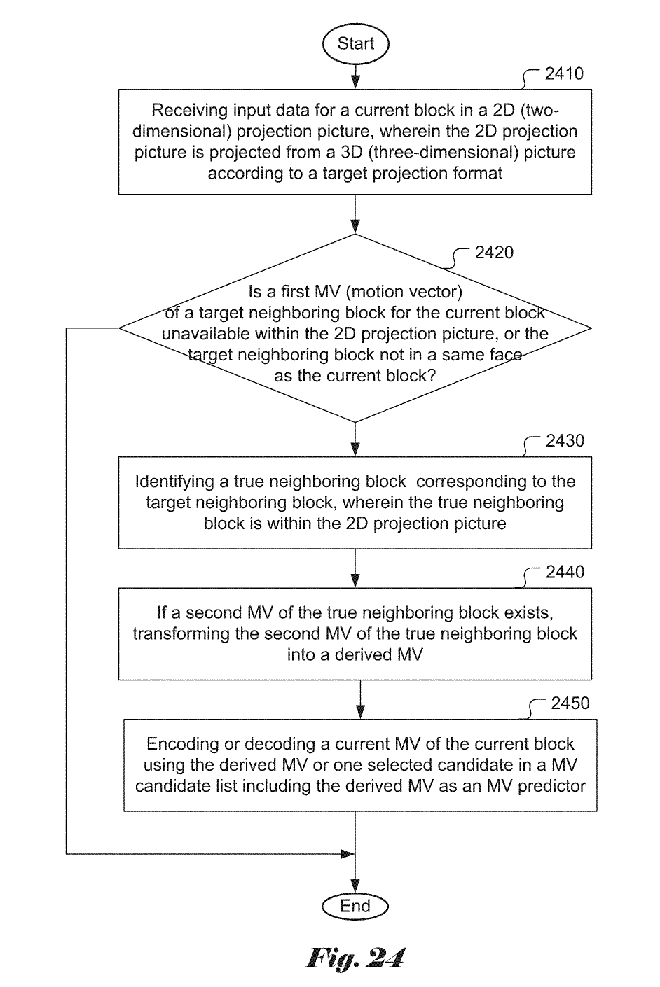

FIG. 24 illustrates an exemplary block diagram of a system incorporating the motion vector (MV) derivation method for VR360 video according to an embodiment of the present invention. The steps shown in the flowchart, as well as other following flowcharts in this disclosure, may be implemented as program codes executable on one or more processors (e.g., one or more CPUs) at the encoder side and/or the decoder side. The steps shown in the flowchart may also be implemented based hardware such as one or more electronic devices or processors arranged to perform the steps in the flowchart. According to this method, input data for a current block in a 2D (two-dimensional) projection picture are received in step 2410, wherein the 2D projection picture is projected from a 3D (three-dimensional) picture according to a target projection format. Whether a first MV (motion vector) of a target neighboring block for the current block is not available within the 2D projection picture or the target neighboring block is not in a same face as the current block is checked in step 2420. If the first MV (motion vector) of a target neighboring block for the current block is not available within the 2D projection picture or the target neighboring block is not in a same face as the current block (i.e., the “Yes” path from step 2420), step 2430 to step 2450 are performed. Otherwise (i.e., the “No” path from step 2420), the process is terminated. In step 2430, a true neighboring block corresponding to the target neighboring block identified, wherein the true neighboring block is within the 2D projection picture. In step 2440, the second MV of the true neighboring block is transformed into a derived MV if a second MV of the true neighboring block exists. In step 2450, a current MV of the current block is encoded or decoded using the derived MV or one selected candidate in a MV candidate list including the derived MV as an MV predictor.

The flowchart shown above is intended for serving as examples to illustrate embodiments of the present invention. A person skilled in the art may practice the present invention by modifying individual steps, splitting or combining steps with departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more electronic circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of coding 360-degree virtual reality (VR360) pictures, the method comprising:
receiving input data for a current block in a 2D (two-dimensional) projection picture, wherein the 2D projection picture is projected from a 3D (three-dimensional) picture according to a target projection format;
when a first MV (motion vector) of a target neighboring block for the current block is not available within the 2D projection picture, or when the target neighboring block is not in a same face as the current block:
identifying a true neighboring block corresponding to the target neighboring block, wherein the true neighboring block is within the 2D projection picture;
if a second MV of the true neighboring block exists, transforming the second MV of the true neighboring block into a derived MV; and
encoding or decoding a current MV of the current block using the derived MV or one selected candidate in a MV candidate list including the derived MV as an MV predictor.

2. The method of claim 1, further comprising when the first MV of the target neighboring block for the current block is available and the target neighboring block is in the same face as the current block, encoding or decoding the current MV of the current block using the first MV of the target neighboring block or one selected candidate in the MV candidate list including the first MV of the target neighboring block as the MV predictor.

3. The method of claim 1, wherein the true neighboring block is identified using a projection-mapping function related to projection and mapping between the 3D picture and the 2D projection picture.

4. The method of claim 3, wherein the projection-mapping function projects a target point outside a current face containing the current block to a corresponding point on a sphere and the projection-mapping function projects the corresponding point on the sphere to a mapped point in another face, and the true neighboring block is identified as an enclosing block containing the mapped point.

5. The method of claim 3, wherein the projection-mapping function projects a target point outside a current face containing the current block to a mapped point in another face, and the true neighboring block is identified as an enclosing mapped block containing the mapped point.

6. The method of claim 1, wherein the true neighboring block is identified using packing information related to projection between the 3D picture and the 2D projection picture.

7. The method of claim 6, wherein the packing information is used to locate a corresponding point in a continuous-boundary neighboring face adjacent to a current face in the 3D picture, and wherein the corresponding point corresponds to a target point outside the current face containing the current block; a true point in a target face corresponding to the continuous-boundary neighboring face in the 2D projection picture is located; and the true neighboring block in the target face is identified as an enclosing block in the target face containing the true point.

8. The method of claim 6, wherein when a target point outside a current face containing the current block is not within any continuous-boundary neighboring face, the packing information is used to map the target point to a corresponding point in a continuous-boundary neighboring face adjacent to the current face in the 3D picture; and wherein the true neighboring block is identified as an enclosing block in the continuous-boundary neighboring face containing the corresponding point.

9. The method of claim 6, wherein the packing information comprises first information regarding neighboring faces for the current block and a corresponding rotation angle associated with each neighboring face.

10. The method of claim 1, wherein a mapping function is used to transform the second MV of the true neighboring block into the derived MV.

11. The method of claim 10, wherein the mapping function uses a set of inputs comprising the second MV of the true neighboring block, a first location of the second MV of the true neighboring block, a first face enclosing the true neighboring block, a corresponding point in the 2D projection picture corresponding to the first location of the second MV of the true neighboring block, a second face enclosing the corresponding point and the target projection format.

12. The method of claim 1, wherein a projection-mapping function is used to transform the second MV of the true neighboring block into the derived MV.

13. The method of claim 12, wherein the projection-mapping function projects the second MV of the true neighboring block in a first face enclosing the true neighboring block onto a second face enclosing the current block.

14. The method of claim 1, wherein packing information is used to derive the derived MV from the second MV of the true neighboring block.

15. The method of claim 14, wherein the packing information comprises first information regarding neighboring faces for the current block and a corresponding rotation angle associated with each neighboring face.

16. The method of claim 1, wherein the target projection format corresponds to Cubemap Projection (CMP), Barrel layout, Segmented-Sphere Projection (SSP), Octahedron Projection (OHP), Rotated Sphere Projection (RSP), Icosahedron Projection (ISP), or Adjusted Cubemap Projection (ACP).

17. The method of claim 1, wherein the MV candidate list corresponds to a Merge candidate list or an AMVP (Advanced Motion Vector Prediction) candidate list.

18. An apparatus for coding 360-degree virtual reality (VR360) pictures, the apparatus comprising one or more electronic devices or processors configured to:
receive input data for a current block in a 2D (two-dimensional) projection picture, wherein the 2D projection picture is projected from a 3D (three-dimensional) picture according to a target projection format;
when a first MV (motion vector) of a target neighboring block for the current block is not available within the 2D projection picture, or when the target neighboring block is not in a same face as the current block:
identify a true neighboring block corresponding to the target neighboring block, wherein the true neighboring block is within the 2D projection picture;
if a second MV of the true neighboring block exists, transform the second MV of the true neighboring block into a derived MV; and
encode or decode a current MV of the current block using the derived MV or one selected candidate in a MV candidate list including the derived MV as an MV predictor.
